(19) United States
(12) Patent Application Publication
(10) Pub. No.: US 2008/0250080 A1
(43) Pub. Date: Oct. 9, 2008

(54) Annotating the dramatic content of segments in media work

(75) Inventors: Juha Arrasvuori, Tampere (FI); Jouka Mattila, Tampere (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/783,027

(22) Filed: Apr. 5, 2007

(51) Int. Cl. G06F 17/30

(52) U.S. Cl. 707/203; 707/E17.009

(57) ABSTRACT

A media work, such as a movie, musical composition, book, or interactive computer game, may be analyzed, segmented, and annotated based on its content. Segment annotations may include a dramatic content level, an indication of thematic importance or key events occurring during the media segment, and other descriptive data relating the content of the media segments. Additionally data identifying the location of the segment within the full version of the media, for example, time codes, page numbers, or game levels, may also be included in the segment annotations. Using an annotated version of the media work, a condensed version may be created based on user preferences and other determined criteria, such as a predetermined time duration, media size, compression ratio, and any content characteristics stored in the segment annotation data.

### BACKGROUND

Modern computing devices and high-speed computer networks enable the rapid communication and replication of media content such as movies, music, electronic books, television programming, and interactive computer games. However, the physical limitations of certain computing devices such as cellular phones, as well as the increasingly busy schedules of many users, often make it impractical or undesirable for users to view or interact with an entire media work. For example, a mobile device user wanting to preview a new movie, play a new computer game, or review a lengthy multimedia presentation on his mobile device, might not have time to watch the entire movie, play the entire game, or watch the entire presentation. Further, the user's mobile device may have storage limitations or physical user interface limitations that prevent the user from viewing or interacting with the media in its original form.

Even the content itself may prevent users from viewing or interacting with a media work in its original form. For example, modern computer games often have complex themes and intricate plots, and may include many twists and obstacles for players to overcome. Such games may require hundreds or even thousands of hours of playing time before a user can eventually “beat the game.” However, the prospect of such a lengthy commitment is intimidating to many casual or beginning gamers. This portion of the gaming community may wish to play only occasionally, and may be content to learn a game by passively observing or playing in only certain simpler levels of a complex multi-level game. Unfortunately, such users are often required to download a complete version of the game, and may be forced to play a more complex and involved version of the game than the gamer would prefer.

Accordingly, there remains a need for annotating and condensing the dramatic content of media works, such as movies, musical compositions, electronic books, television programming, and computer games, to make the media more accessible to different users and to different computing environments.

### SUMMARY

The following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

According to one aspect of the present disclosure, a media work, such as a movie, musical composition, television program, music video, computer animation, streamed content (e.g. streaming radio available via the Internet), electronic book, or interactive computer game, may be analyzed based on its content and other characteristics. Distinct segments may be identified within the media work, and each identified segment may be annotated based on its dramatic content, thematic importance, and other characteristics or events occurring within the segment. An annotated version of the media work may be created including information describing the identified segments, along with references to the original media work. The annotated version may be entirely separate, partially integrated, or fully integrated into the original media work.

According to another aspect of the present disclosure, the annotated version of the media work may be used to create a condensed version of the media work based on user preferences and other criteria for the condensed media. A condensed media version may include a selected subset of the media segments, based on the dramatic content or thematic importance information in the annotated segments, and other criteria determined by a user when requesting the condensed media version. For example, a user may request a specific time duration for a condensed media version, corresponding to the amount of free time that the user has for viewing the condensed media. Multiple condensed versions of a single media work may be created based on the different criteria of different users and different devices that will be viewing and executing the condensed media, for example, media size, time duration, or the specific content characteristics of the media segments (e.g., action sequences, specific characters). For computer games, condensed game versions may be created including selected game scenes or levels, challenges, puzzles, tasks, opponents, and selected types of user interactions.

According to yet another aspect of the present disclosure, a remote terminal subscriber may request a condensed version of a media work from a service provider operating as a condensed media server. For example, a mobile device in communication with a mobile service provider may request a condensed version of a movie or a computer game based on the user's preferences and the specifications of the mobile device. According to other aspects of the present disclosure, larger media works such as complex multi-level games, may be condensed and provided to subscribers in periodic installments or episodes of the condensed media work.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating a computing device, in accordance with aspects of the present invention;

FIG. 2 is a block diagram illustrating a network communication system comprising a server and multiple remote terminals, in accordance with aspects of the present invention;

FIG. 3 is a flow diagram showing illustrative steps for creating an annotated version of a media work, in accordance with aspects of the present invention;

FIGS. 4A-4B illustrate two examples of movie annotation files, in accordance with aspects of the present invention;

FIG. 5 is a flow diagram showing illustrative steps for creating a condensed version of a media work based on an annotated version of the media work, in accordance with aspects of the present invention;

FIGS. 6A-6B are diagrams graphically illustrating the dramatic content of an annotated media work and identifying selected segments of the illustrative media work, in accordance with aspects of the present invention;

FIGS. 7A-7B illustrate two examples of condensed media files, in accordance with aspects of the present invention;

FIG. 8 is a flow diagram showing illustrative steps for requesting and executing a condensed version of a media work, in accordance with aspects of the present invention; and

FIG. 9 is an illustrative user interface for receiving user input and requesting a condensed version of a media work, in accordance with aspects of the present invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

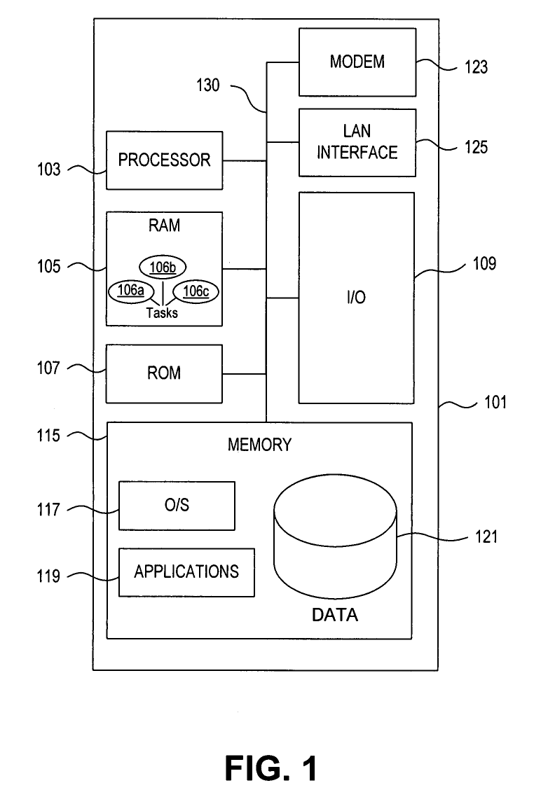

FIG. 1 illustrates a block diagram of a generic computing device 101 that may be used in accordance with certain embodiments of the invention. Device 101 may include a processor 103 for controlling the overall operation of the computing device and its associated components, including RAM 105, ROM 107, input/output module 109, and memory 115. Also shown inside the RAM 105 are applications 106a-106c, representing the application data stored in RAM memory 105 while the computer is on and corresponding software applications (e.g., software tasks) are running on the computer 101, including, for example, system applications and user applications, such as native applications or managed applications executed in a managed runtime environment. Thus, computer 101 typically includes a variety of computer readable media, and combinations of the any of the above should also be included within the scope of computer readable media.

I/O 109 may include a microphone, keypad, touch screen, and/or stylus through which a user of device 101 may provide input, and may also include one or more of a speaker for providing audio output and a video display device for providing textual, audiovisual and/or graphical output. I/O 109 may also include a user interface including such physical components as a voice interface, one or more arrow keys, joy-stick, data glove, mouse, roller ball, or the like. Memory 115 may store software used by device 101, such as an operating system 117, application programs 119, and associated data 121. Additionally, an application program 119 used by device 101 according to an illustrative embodiment of the invention may include computer executable instructions for invoking system and/or user functionality. For example, an application program 119 used by the device 101 according to an illustrative embodiment of the invention may include computer executable instructions for invoking user functionality related to communication, such as email, short message service (SMS), multimedia messaging service (MMS), and voice input and speech recognition applications.

The device 101 may operate as a server in a networked environment supporting connections to one or more remote computers, such as personal computers, mobile devices, or other servers that include many or all of the elements described above relative to device 101. Thus, the device 101 may support connections to various networks, including local area networks (LANs), wide area networks (WANs), and many other varieties of communication networks. When used in an Ethernet or other LAN networking environment, the server 101 may be connected to the LAN through a network interface or adapter 125. When used in a WAN networking environment, the server 101 may employ a modem 123 or other techniques for establishing communications over the WAN. It will be appreciated that the network connections described herein are illustrative and other techniques for establishing communications links between computers may be used.

Device 101 may also be part of a mobile communication system. Such systems are well-known in the art to include one or more base stations communicating with one or more mobile terminals via radio communication. The device 101 may be a base station in such a system, configured to perform baseband and radio frequency processing. The device 101 may also be a mobile terminal including various other components, such as a battery, speaker, and antennas (not shown). Additionally, the memory 115 of computer 101 may be implemented with any combination of read only memory modules or random access memory modules, optionally including both volatile and nonvolatile memory and optionally being detachable. Software may be stored within memory 115 and/or storage to provide instructions to processor 103 for enabling computer 101 to perform various functions. Alternatively, some or all of computer 101 computer executable instructions may be embodied in hardware or firmware (not shown). Additionally, device 101 may be a mobile terminal configured to send and receive transmissions through various device components, such as an FM/AM radio receiver, wireless local area network (WLAN) transceiver, and telecommunications transceiver (not shown). In one aspect of the invention, mobile terminal 101 may also receive IP datacasting transmissions via a DVB and/or DVB-H receiver. Mobile terminal 101 may be equipped with other receivers/transceivers, e.g., one or more of a Digital Audio Broadcasting (DAB) receiver, a Digital Radio Mondiale (DRM) receiver, a Forward Link Only (FLO) receiver, a Digital Multimedia Broadcasting (DMB) receiver, etc. Hardware may be combined to provide a single receiver that receives and interprets multiple formats and transmission standards, as desired. That is, each receiver in a mobile terminal 101 may share parts or subassemblies with one or more other receivers in the mobile terminal device, or each receiver may be an independent subassembly.

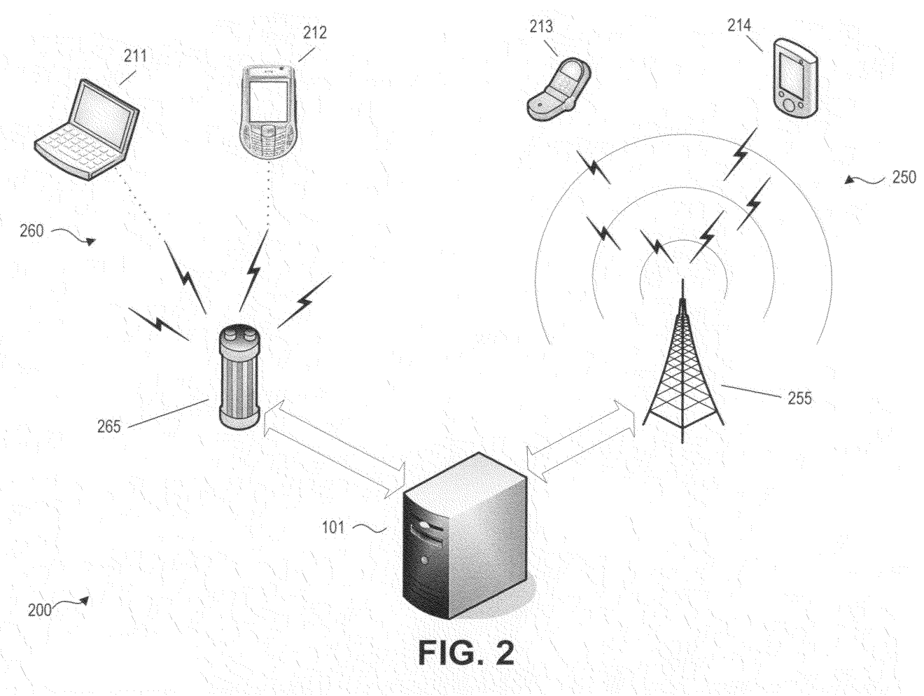

Aspects of the present invention may be utilized across a broad array of networks and communication protocols. FIG. 2 illustrates an example of a communication system 200 in which systems and methods according to at least some embodiments may be employed. One or more network-enabled remote terminal devices 211-214, which may be, for example, personal digital assistants (PDAs), cellular telephones, mobile terminals, personal home computers, laptop computers, digital cameras, portable audio devices, or combinations thereof, are in communication with computer 101 through network system 200 (which may include combinations of Ethernet and other LAN connections, WAN connections using the Internet 240, broadcast network 250 and/or cellular network 260. The remote terminals (e.g., mobile devices 211-214) may comprise digital broadcast receivers. The computer 101 may be connected to one or more service providers that may provide their actual program content or information or description of their services and programs to the service source that further provides the content or information to the mobile devices 211-214. The service providers may include but are not limited to one or more television and/or digital television service providers, analog and/or digital AM/FM radio service providers, SMS/MMS push service providers, Internet content or access providers.

The broadcast network 250 may include a radio transmission of IP datacasting over DVB and/or DVB-H, and may broadcast a service such as a digital or analog television signal and supplemental content related to the service via transmitter 255. Supplemental content transmitted via the broadcast network 250 may include a television signal, audio and/or video streams, data streams, video files, audio files, software files, and/or video games. In the case of transmitting IP datacasting services, the service source may communicate actual program content to user devices 211-214 through the broadcast network 250 and additional information such as user rights and access information for the actual program content through the cellular network 260.

As mentioned above, the mobile devices 211-214 may also be in communication with the computer 101 (e.g., via an intermediate service source) through the cellular network 260. The cellular network 260 may include a wireless network and a base transceiver station transmitter 265. The cellular network may include a second/third-generation (2G/3G) cellular data communications network, a Global System for Mobile communications network (GSM), or other wireless communication network such as a WLAN network.

The mobile devices 211-214 may also include wireless interfaces configured to send and/or receive digital wireless communications within the cellular network 260. The information received by mobile devices 211-214 via the cellular network 260 or broadcast network 250 may include user selection, applications, services, electronic images, audio clips, video clips, and/or WTAI (Wireless Telephony Application Interface) messages. As part of cellular network 260, one or more base stations may support digital communications with receiver devices 211-214 while these devices are located within the administrative domain of cellular network 260.

Examples of other digital broadcast standards which communication system 200 may utilize include IP datacasting standards such as DVB and/or DVB-H, Digital Video Broadcast-Terrestrial (DVB-T), Integrated Services Digital Broadcasting-Terrestrial (ISDB-T), Advanced Television Systems Committee (ATSC) Data Broadcast Standard, Digital Multimedia Broadcast-Terrestrial (DMB-T), Terrestrial Digital Multimedia Broadcasting (T-DMB), Forward Link Only (FLO), Digital Audio Broadcasting (DAB), and Digital Radio Mondiale (DRM). Other digital broadcasting standards and techniques, now known or later developed, may also be used. An aspect of the invention is also applicable to other multicarrier digital broadcast systems such as, for example, T-DAB, T/S-DMB, ISDB-T, and ATSC, proprietary systems such as Qualcomm MediaFLO/FLO, and non-traditional systems such 3GPP MBMS (Multimedia Broadcast/Multicast Services) and 3GPP2 BCMCS (Broadcast/Multicast Service).

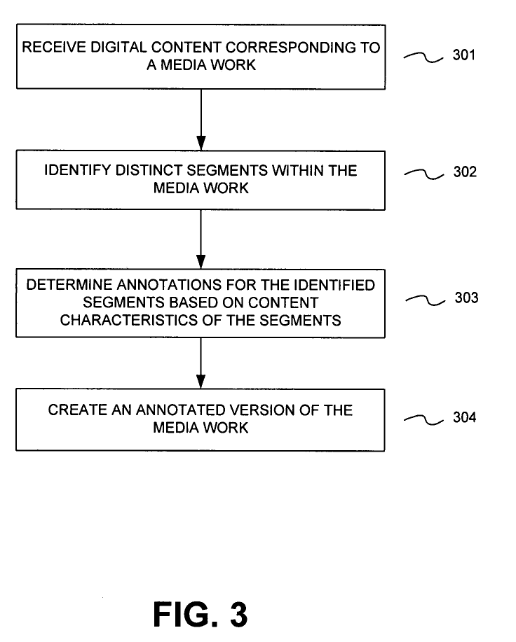

Referring to FIG. 3, a flow diagram is shown illustrating steps for creating an annotated version of a media work, in accordance with aspects of the present disclosure. As noted above, a media work may correspond to a movie, electronic book, television program, musical composition, audio and/or video streams, data streams, software files, and other multimedia content. Thus, although certain examples below describe annotating and condensing a digital movie file, the techniques described herein are not limited to any particular media type.

As with conventional methods of annotating media, the creation of an annotated version of a media work may be performed manually by a human (e.g., an author, director, screenwriter, editor, producer, or programmer of the media content) or by computer software using automated techniques for creating the annotated media version. Additionally, annotation files may be created concurrently with the media work or afterwards, for example, by a viewer or consumer of the media. Thus, different techniques for annotating media may be used at different times by different people, potentially resulting in many different annotated versions of the same media. For example, a first movie annotation file may be created by the movie producers and integrated into the media work itself (e.g., as metadata within the digital movie file), while a second annotation file may be created by a fan of the movie and stored separately from the movie file on his or her own computer 101.

In step 301, digital content of the media work, for example, a digital movie file, is received at a computing device 101. The media work may be received, for example, from an external movie producer or distributor, or might already be stored in memory 115, such as when the author creates an annotated version of the media work concurrently with the media itself. Thus, step 301 may comprise a local software process for annotating media receiving the media content via interprocess communications with a media generation or editing task running on the same computer 101.

The media work received in step 301 may consist of a single or multiple related media files. For example, a movie may be stored as a single media file, or as different files corresponding to different movie scenes. Additionally, a single annotation file may correspond to multiple movies, for example, a science fiction movie and its two sequels may all be annotated together into a single annotation file. Thus, receiving the media work in step 301 may comprise downloading into memory 115 many different digital multimedia files. Similarly, for computer games, the content received in step 301 may consist of an entire computer game, or only a portion of the game (e.g., a game scene, level, or episode). Additionally, depending on the design, platform, and implementation of the computer game, the received content may closely resemble other media content, such as movies or multimedia files and interactive media, or may more closely resemble software files. Either way, the computer game might be stored as multiple different digital files (e.g., executable game files for different game scenes or different characters, files containing game level definitions, game character artificial intelligence definitions, user settings, sound files, image files, game character items, etc.), rather than being represented by a single file. Therefore, conveying the computer game content in step 301 may require transmission and receipt of multiple game files.

In step 302, distinct media segments are identified with the media content received in step 301. As noted above, segmenting a media work may be performed manually by a human user (e.g., a movie screenwriter), or by a computer 101 using automated techniques to identify distinct media segments within the content. For example, computer software-based techniques may be used to calculate the dramatic content of different portions of a movie, electronic book, musical track, etc., and to determine the segmentation of the media based on these calculations. For instance, a movie soundtrack may be analyzed using computer software to detect certain dramatic content, such as action sequences, comedic portions, and dramatic climaxes. Additionally, the actors' speech characteristics may be analyzed to identify whispering, shouting, etc., and other movie sound effects such as gunfire and explosions may be used to help determine the dramatic content and the key events occurring within of that portion of the movie. The visual complexity of the media content may also be analyzed to detect scene changes, motion, and the amount of action in this portion of the movie. Additionally, the computer software may have access to the media script text in a digital format, and may analyze the script to identify specific words or phrases.

Based on this media content data and these analyses, computer calculations may be performed using conventional techniques to identify distinct media segments based on the content characteristic of each segment. For example, in step 302, media segments may be identified that correspond to single scenes in a movie or television program. In another example, a multi-scene movie action sequence lasting several minutes may be identified as a single segment, because it is distinguishable from the portions of the movie on either side by the soundtrack and volume, the screen motion, the intensity of the dialogue level, and the distinguishable action sounds effects.

In another example of step 302, the content of a computer game may be analyzed, for example, by parsing the game file(s) (e.g., game level script files) to identify different game segments. As mentioned above, game segments may be determined by the amount of time a user spends viewing or interacting with a certain scene or background display within the game. Game segment division may also be determined automatically or performed manually by a user to correspond to game levels, opponents, challenges, tasks, puzzles, etc. Game programmers, developers, or distributors may also pre-segment games, for example, by identifying different game levels and providing descriptive data for the level in a documentation file or application programming interface (API).

In step 303, descriptive annotations are determined for each of the identified segments in the media work. For example, the media segments may be annotated based on the above-described analysis of the dramatic content of the segments. For instance, a movie with a simple 5-part dramatic structure might have each of its segments annotated with the part of the structure in which the segment occurs (e.g., exposition, rising action, climax, falling action, or denouement). Segment annotations may also indicate the occurrence of an important event, for example, with an event indicator and an importance rating for the event. Thus, as described below, it may be possible to create a condensed media version including the most important segments from the media, for example, by selecting the segments with the highest thematic importance rating or an event indicator with a high importance level. In other variations, other criteria besides thematic importance may be used to select segments for the condensed version. Therefore, annotations for the identified media segments may also indicate, for example, the presence of an action or comedy sequence in the segment, or may identify the set of characters that appear during the segment.

For any media type, the segment annotations may also identify the location of the segment by referring back to the original version of the media work. Thus, for movies, television programming, and other similar media, the segment annotations may include time codes that mark the segment boundaries within the media work. In contrast, if the media work represented an electronic book, then the segment annotations may include page numbers and line number of the book marking the segments. For interactive computer games, the segment annotations may include the game level and/or the different game scenes and challenges faced at the stages in the game corresponding to the segments.

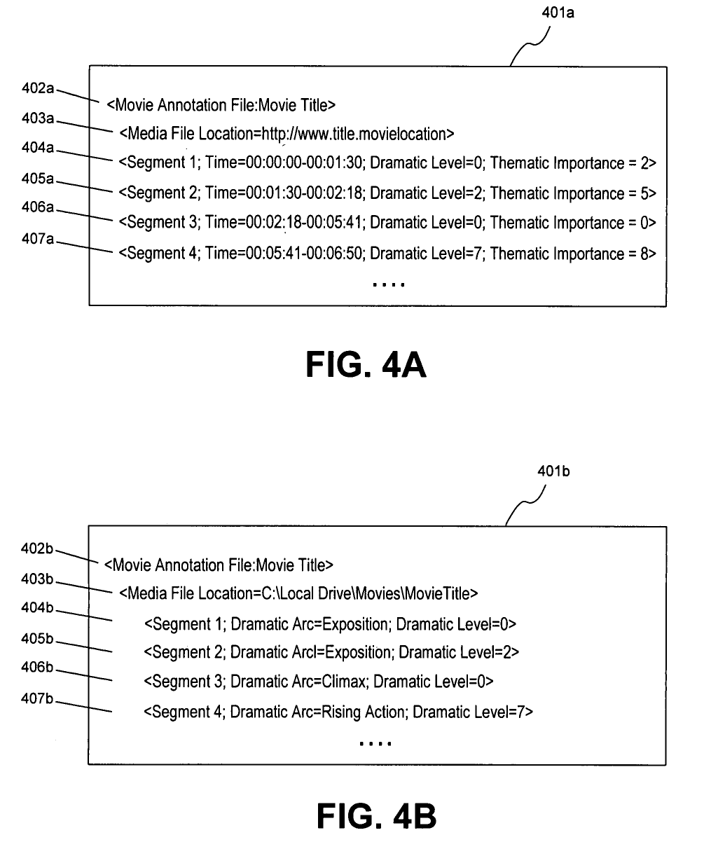

In step 304, an annotated version of the media work is created. For example, computer 101 may create and store an annotation file in memory 115 that is separate from the media work itself. Thus, an annotated media version need not contain any of the actual media content, but might only reference the media content with data such as segment time codes, page and line numbers, game levels, etc. FIGS. 4A and 4B, discussed in detail below, illustrate two examples of annotation files created based on a media work.

In other embodiments, the annotated version of the media work may be integrated into the original media work. Media annotation data may be embedded into the media work so that the annotated version of the media work will produce the same media experience as the original version. For example, the annotation data for a segmented and annotated movie might be stored on the physical media with the movie (e.g., DVD, computer hard drive), but in a location on that media that does not affect the ability to play the movie in its original form. Similarly, in a computer game, the annotated version of the game might include segment designations and annotations that are completely hidden from the game players. Many commonly known techniques such as tagging, properties, and metadata may be used to create and store the annotations. In one example, the software code corresponding to the game may be instrumented with dummy instructions which contain segment and annotation information but which are not executed as part of the game execution. As another example, the annotations may be stored in a separate physical media from the original media work, with references linking the segments and annotations to the appropriate locations within the media work.

Referring to FIGS. 4A and 4B, two examples of portions of annotations files based on a movie are shown. As discussed above, the annotation files 401a and 401b define the set of segments into which the corresponding movie may be partitioned, and may be generated by a human user, by a computer, or by a combination of manual and automated techniques. As shown in these examples, annotation files for media works may be stored in an extensible markup language (XML) format, or other similar format to provide the annotated versions of media works in a software application-independent and platform-independent form, so that users in different computing environments may conveniently create and share annotation files of different media works.

In these examples, the annotation files 401a and 401b each contain an initial tag 402a and 402b containing the title of the annotation file. As discussed above, there are many different possible authors and techniques for segmenting a media work. Therefore, many different annotation files may potentially be created for a single media work, and the title tags 402a and 402b may be used to identify and distinguish among different annotation files. Annotation files may include other identifying tags such as date tags or author tags that may used for similar purposes.

The annotations files 401a and 401b also contain media file location tags 403a and 403b to provide the location at which the full version of the media work is stored. This location may be a local file path (as in 403b) or a remote address (as in 403a) such as a network URL or other remote file path identifier. As noted above, an annotation file may correspond to a media work comprising multiple media files, for example, a movie and its sequels. In such examples, multiple media file location tags 403a and 403b may be created in the annotation file, or alternatively, a single media file location tag may be used, for example, with multiple separate tag attributes for each different media file.

Tags 404a-407a represent the different segments with the single movie associated with the annotation file 401a. In this example, each segment 404a-407a includes two time codes separated by a dash, corresponding to the start time and end time of the segment within the movie. Each tag 404a-407a also includes a dramatic content level (0-10), and a thematic importance level (0-10). In the annotation file 401b, the segment tags 404b-407b also include a dramatic content level for each segment in the movie, as well as a text description of the segment's position in the overall dramatic arc (e.g., exposition, rising action, climax, falling action, or denouement) of the media work.

In other examples, annotation files may include segment tags with attributes indicating the presences of a particularly important thematic event within the segment, for example, an event that the author of the annotation file believes should be included in almost any condensed version of the media work. Further, segment tag attributes may indicate an action level or comedy level of the segment, or identify the characters that appear in the segment. In other examples, since potentially any information relating to the content of the different segments might be relevant to the author/viewer of a condensed media version, potentially any different type of media content information may be stored in the segment tags or attributes of an annotation file.

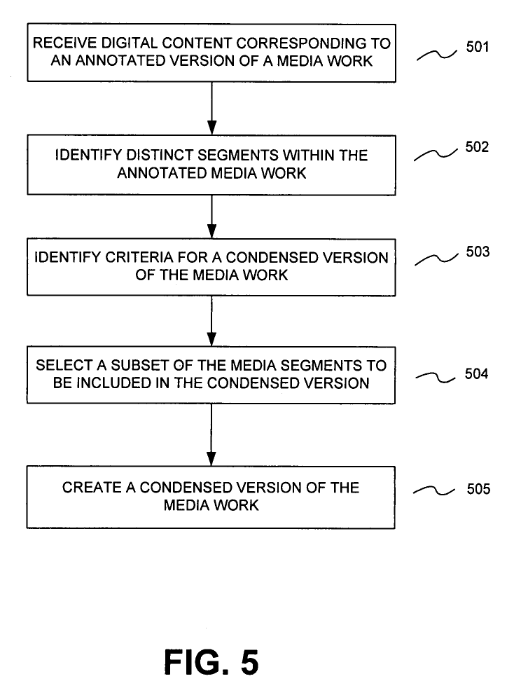

Referring to FIG. 5, a flow diagram is shown illustrating steps for creating a condensed version of a media work based on annotations in the media work, in accordance with aspects of the present disclosure. Thus, the above-discussed techniques for annotating media works may be performed just prior to creating the condensed media. In certain embodiments, a single computer 101 may receive a media work and perform the steps of both FIGS. 3 and 5 in sequence, first annotating and then condensing the media work. This computer 101 may perform the separate tasks individually (e.g., in different software components or processes) using interprocess communication to synchronize the tasks, or may perform the annotating and condensing in a single task or process. Alternatively, the different tasks of annotating and condensing may be performed by different computers 101 controlled by different parties. For example, a computer game developer or distributor may annotate segments of a new game with dramatic content and then ship the game to their customers, including the necessary documentation to allow the customers to access and/or update the segment annotations. A customer, for example, a mobile service provider, may then receive the annotated game and may condense and distribute the game to its subscribers. Additionally, as described below, the game may be condensed in multiple different ways, enabling different customers to produce different condensed versions of the game to meet the needs of their subscribers.

In step 501, the computer 101 receives an annotated version of a media work (e.g., an annotation file). As discussed above, the annotation file may correspond to an movie, electronic book, musical composition, computer game, or other media work. The computer 101 may receive an annotation file corresponding to a media work already stored in the computer memory 115 or accessible to the computer 101 over a computer network, although the actual media work need not necessarily be available when creating a condensed media version based on an annotated media version. In certain scenarios, a user may receive one or more annotation files along with the media work itself. As noted above, the annotation file need not include any of the actual content of the media work, but might only include references to the media work. In certain embodiments, storing a media work remotely from the computer 101 may provide advantages in efficiency for transmission and storage, because the portions of the media work that are ultimately not included in the condensed version need not be transmitted or stored at computer 101 at any point in the process.

In step 502, the distinct segments within the media work are identified, for example, by parsing the annotation file received in step 501. As mentioned above in reference to FIG. 3, the segment data (e.g., segment tags and attributes) in the annotation file may include starting and stopping times for each segment and/or a segment duration time, dramatic arc data, a dramatic content level, thematic importance, and other data relating to the content of the media segments. For computer games, rather than time codes, the segment data may correspond to game episodes, game scenes, levels, or challenges, etc.

In step 503, one or more criteria for creating the condensed media work are identified. One criterion may be a duration for the condensed version of the media work, or as an alternative, a criterion may be a compression ratio corresponding to the full media version. For example, the creator of a condensed version of a movie may require that the condensed movie be no longer than 20 minutes. In another example, the creator of a condensed television program may want the program condensed with a compression ratio of 4:1, meaning that only 25%, or one out of every four segments (assuming equal length time-sliced segments) will be included in the condensed version. Other criteria for the condensed version may be based on user preferences or other predetermined settings, for example, a storage or memory limitation for a mobile terminal that will play the condensed version.

In certain embodiments, the criteria received in step 503 may be received from a remote media “subscriber” computer via network interface 125 or modem 123. For example, if the computer 101 functions as a service provider for mobile devices 211-214, then the devices 211-214 may request a particular condensed media by initiating a communication with the service provider 101 via the broadcast or cellular network 250 or 260. Additionally, a device 211-214 may be able to subscribe to receive periodic installments of condensed media, for example, weekly game episodes of the user's favorite computer game, sent directly to the user's mobile device 211-214. In this example, the user requesting a condensed “preview” version of a computer game might specify a certain preview time in the request (e.g., 5 minutes). Alternatively, the mobile device 211-214 itself might communicate the condensed media requirements to the provider 101 based on its storage capacity or other hardware limitations. For example, the physical user interface of the mobile device 211-214 may limit the different game levels or challenges that the user may play on the condensed game preview. Further, the server provider 101 itself may be able to detect or infer the hardware limitations of a requesting device, and impose its own set of requirements to accommodate the device 211-214.

The criteria for the condensed media may also depend on the type and format of the media itself, and on the strategic business decisions of the media author or distributor in making the condensed media available. For example, a condensed media for a music album may include a single small time segment for each musical track on the album. As another example, a movie fan creating a condensed version of a movie may want to include all segments which include his favorite character in the movie. In yet another example, criteria received in step 503 for creating a condensed version of a computer game may define the desired number of game levels for the condensed version, a time limit for playing within each level, a maximum number of game challenges or points, or a limit on the game characters accessible to the player within the condensed version.

Additionally, the criteria for condensed media versions may depend on the strategic business decisions of the media distributor. For example, a condensed media version may be distributed as a marketing technique to pique consumer interest in the game, movie, etc., and to entice sales of the full (non-condensed) version of the media work. Similarly, as discussed above, a condensed media work may represent a first episode of an ongoing computer game, movie, or other media. The condensed episodes may be distributed on a periodic schedule to media subscribers.

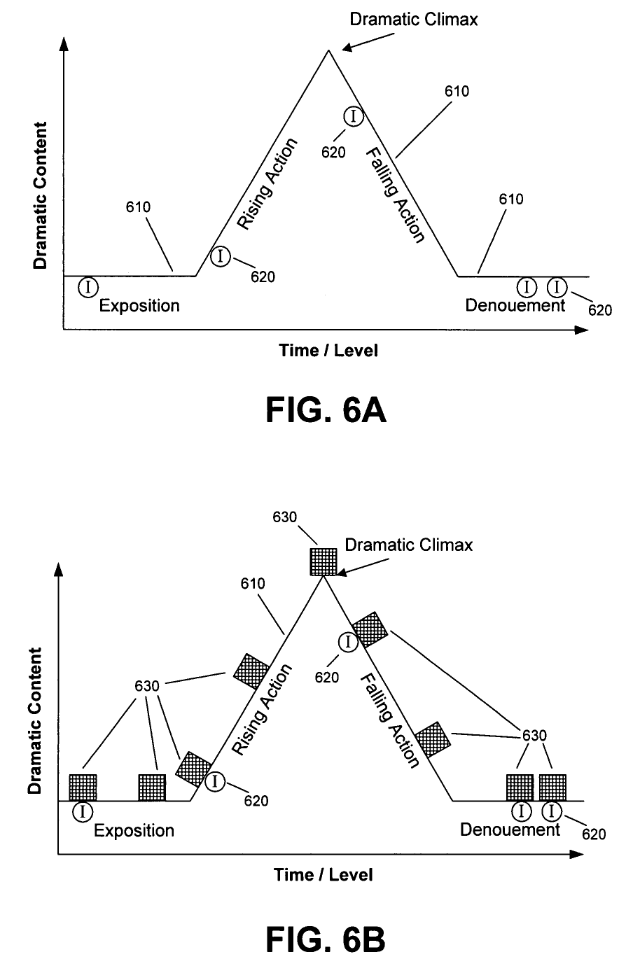

In step 504, a subset of annotated media segments is selected for inclusion into the condensed media, either manually by a user, automatically using computer software-based techniques, or with a combination of manual and automatic techniques. As discussed above in reference to step 303, the selection of the specific media segments may be based on the segment duration, the dramatic content of the segment, the importance of the events that occur within the segment, and other factors at the discretion of the requester or creator of the condensed version of the media work. Thus, in step 504, an automated software process executing on the computer 101 may use the above criteria and preferences to parse through the annotation file and select the subset of media segments to be included into the condensed media. As an example, if the only user-specified criteria for a condensed version of a movie was a time duration criteria, then an automated software process in step 504 might continually select the segment with the highest dramatic content level from the remaining media segments until the time limit is reached. As another example, the software process may traverse the segment annotation file to select a set of media segments that appropriately characterize the overall dramatic arc of the entire media. For example, if a media composition such as a book, movie, or complex computer game has the 5-part dramatic structure shown in FIG. 6A, the computer 101 in step 504 may select segments equally from the different parts of the dramatic arc. In yet another example, a graphical user interface for manually creating a condensed version of a media work may be provided, in which the different segments of the annotated version are rendered on a display screen (e.g., with a single image representing each segment, or a line graph charting the dramatic arc and identifying key events), thereby allowing the user to manually select the individual segments to be included in the condensed media version.

As noted above, segment selection may also be based on a specific feature of the segment's dramatic content, namely the importance of events occurring within the segment. When a certain event or dramatic plot twist in a movie, book, television program, or game is critical to understanding the overall theme, the segment tags in the annotation file may indicate that the segment contains a critical event and is required for condensed versions. Thus, any segment containing a required event would typically be selected for the creation of a condensed version of the media work. Events may have a numerical importance rating (e.g., 0 to 10) indicating the relative importance of the event to the story. Using this range of ratings, a larger condensed media might automatically select more events than a smaller condensed version of the same, although the smaller condensed version will still select the most important events in the story.

Finally, in step 505, the condensed version of the media work is created using the subset of segments selected in step 504. In certain embodiments, the condensed version of the media, like some annotation versions, may contain none of the actual media content, but only references identifying segments and/or creating direct links to the appropriate locations within the media work. In other examples, the condensed version of the media work might only reference the annotated version of the media work, which in turn references the full version of the media work.

Referring to FIGS. 6A and 6B, graphical representations are shown of the dramatic content of a media work. In this example, these graphs have been automatically generated by charting the dramatic content, thematic importance, and key event data from the segment tags of an illustrative annotation file, for rendering this representation and allowing a user to manually select the segments to be included in a condensed media version. In FIG. 6A, the graph shown illustrates that the media work has a basic five part dramatic arc 610 (i.e., exposition, rising action, climax/turning point, falling action, and denouement). In other examples, different predefined types of dramatic structures and dramatic arcs may be used to annotate and condense a media work. Additionally, as described above, the dramatic arc of the media may be determined on the fly based on an analysis of the media content, for example, during the segmentation and annotation of the media work. A dramatic arc or dramatic structure may be associated with many different media types, such as books, music, movies or television programming, or interactive computer games.

Referring again to FIG. 6A, the X-axis measures the chronological progression of the media from its beginning at the left side of the graph to its ending at the right side. Thus, if the dramatic arc 610 represented a movie, then the X-axis might simply be the running time of the movie, while a dramatic arc 610 representing a book might have an X-axis corresponding to the page number. For an interactive media, such as a computer game, the X-axis of the dramatic arc 610 may correspond to the game scene or background, the playing time, the average/anticipated playing time, the game level, game points achieved, etc., or some combination of these factors.

Several events 620 occurring within the media work, which are important to the overall story of the media, are also shown in FIG. 6A. Each of these events 620 is identified on the graph as an “I” within a circle and positioned on the dramatic arc 610 in the location corresponding to the time/level that the event takes place. Although not shown in FIG. 6A, each of these events 620 may have an associated importance rating (e.g., 0 to 10). Thus, when the media work shown in FIG. 6A is segmented and annotated for dramatic content, the annotations for a segment may describe the chronological location of the segment within the overall media (e.g., a time range, page range, game level), the part (or slope) of the dramatic arc 610 (e.g., rising action, dramatic climax, denouement), and the importance rating of any events 620 within the segment.

Referring to FIG. 6B, a graph is shown illustrating a set of segment selections 630 corresponding to the media work represented in FIG. 6A. Using techniques similar to those described above, the selected segments 630 in this graph correspond to a representative sample of the dramatic arc 610 of the media work, including one or more segments from each of the different parts of the dramatic structure. Additionally, all of the segments containing required thematic events 620 were selected. Finally, in this example, based on the size and/or time limits for the condensed media version to be produced, additional segments have been selected from different parts of the media work, for example, to include other important but not required events, or to better correspond to the dramatic arc 610. As noted above, the selection of segments may be performed entirely manually, entirely automatically, or as a combination of manual and automated selection techniques. For example, a user may provide via input a set of selection priorities and criteria, then a software process may automatically select the segments based on those user-provided criteria.

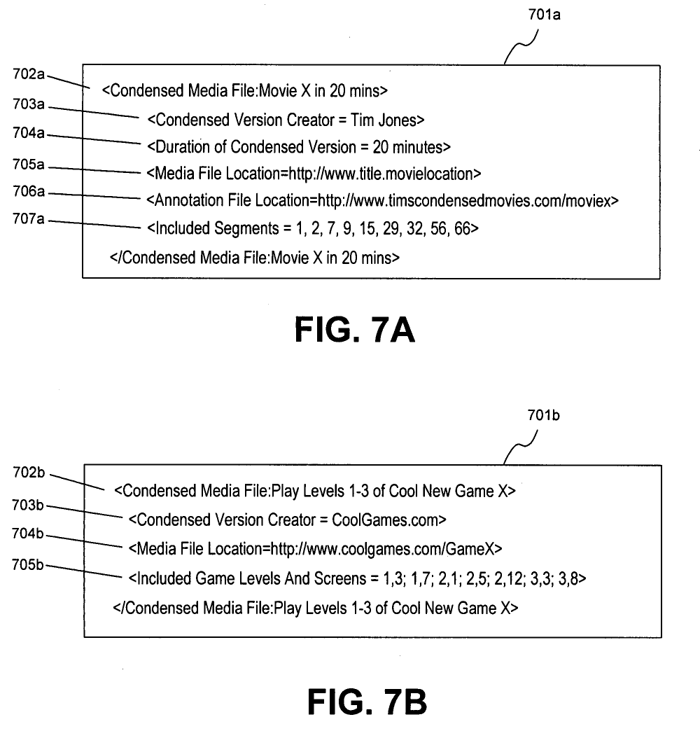

Referring to FIGS. 7A and 7B, two examples are shown of condensed media files based on media works and/or annotation files. In these examples, the condensed media files 701a and 701b, like annotation files 401a and 401b, are generated in XML format, with predefined tags and attributes for storing the relevant data describing the condensed media. Tags 702a and 702b identify the files as condensed media files and provide a descriptive title for the condensed media file, while tags 703a and 703b store the author of the condensed media file. Thus, in these examples, the file 701a defines a condensed 20-minute version of a movie generated by a user, Tim Jones, and the file 701b defines a condensed version of levels 1-3 of an interactive computer game generated by the game manufacturer, CoolGames.com.

As discussed above, a condensed media file need not include any of the actual media content, but may instead include references to the full media version of the media work. Thus, in order to play a particular condensed media version, a user might need access to both the condensed media file and the media work itself. Accordingly, it may be advantageous for condensed media files to include the locations of the corresponding media work and/or an annotation file for the media work, so that the correct media segments and quickly and conveniently be retrieved during execution of the condensed media version. In this example, condensed media file 701a includes a tag 705a identifying the location of the media work, another tag 706a identifying the location of the annotation file, and a third tag 707a defining the segments included in the condensed movie. Thus, the software process executing the condensed movie file 701a might first access the annotation file to retrieve the time codes for the selected segments identified in tag 707a, and then access the media file to request the movie content corresponding to those time codes.

The condensed media file 701b includes a tag 704b providing the location of the game files, and a tag 705b defining the game levels and scenes but does not include an annotation file tag. Thus, the software process executing the condensed game file 701b need not interact with an intermediate annotation file, but may directly request the media game files (e.g., via an API provided by the gaming software) to pass in the included game level and scenes, and receive the game content back from the game files. For example, the process executing the condensed game file may receive a set of pointers or functions allowing users to play the specific game portions for these levels and scenes, without requiring the user to play any of the preceding or following game levels or scenes.

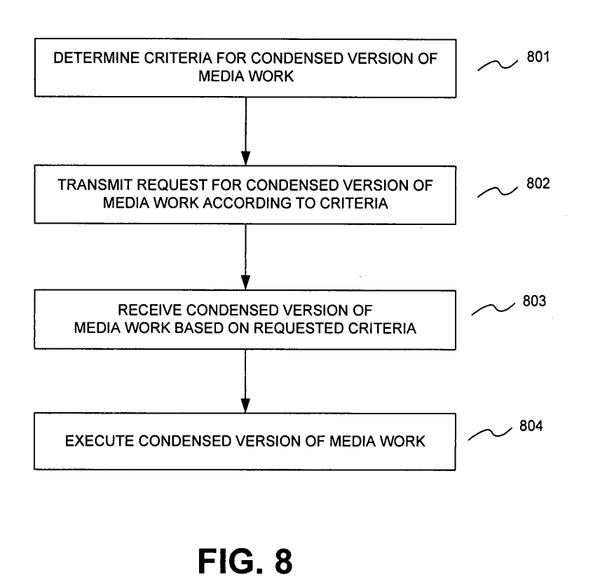

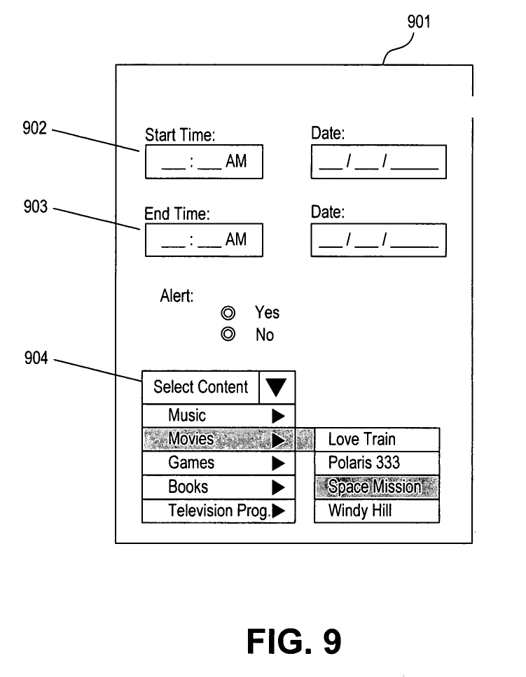

Referring now to FIG. 8, a flow diagram is shown illustrating steps for requesting and executing a condensed version of a media work, in accordance with aspects of the present disclosure. In step 801, a set of criteria for the condensed version may be determined, for example, with user input received via a user interface 901 (FIG. 9) on a mobile device 211-214. For example, step 801 may include receiving user input identifying a specific media work and defining a time duration for the condensed media version. As discussed above, a condensed media version may be generated from an annotated media version based on different aspects of content characteristics (e.g., dramatic content level, important thematic events, action sequences, characters, soundtrack), and based on other properties of the media work and media segments. Accordingly, different user interfaces may be designed to allow users to customize condensed media versions to their individual preferences. In certain embodiments, the input controls of a user interface may be designed on the fly based on the specific information stored in the annotation file(s) accessible to the mobile device 211-214, so that the user may specify criteria based on any of the information in the annotation files, when requesting a condensed media version.

In step 802, the computer (e.g., mobile device 211-214), transmits a request (e.g., to a media server) for a condensed version of a media work based on the one or more user or device criteria determined in step 801. As discussed above, device criteria may relate to a predetermined duration, size, or compression ratio for the condensed media based on the available memory of the device 211-214, or may relate to the physical user interface of the device 211-214. The user criteria may relate to a desired time duration or compression ratio for the condensed media version, as well as to the content of the media work.

In step 803, a condensed version of the media work, for example, a condensed media file like 701a or 701b, may be transmitted from the media server to the requesting mobile device 211-214. In certain embodiments, the mobile device 211-214 may include a DVB and/or DVB-H receiver, and the condensed media work may be downloaded using the DVB or DVB-H IP datacasting standards.

In step 804, the mobile device 211-214 may execute the received condensed version of the media work. As described above, execution of a condensed media version may include opening and parsing the condensed media file to retrieve the selected media segments, then accessing the appropriate media annotation file and/or the full version of the media file to retrieve the segment content for local execution on the mobile device 211-214. The actual execution of the media content will depend on the media type. For example, playing a condensed movie or television program may require invoking a software multimedia player installed at the mobile device 211-214, while playing a condensed game version may include initiating a game executable file received from the media server in step 803.

Referring to FIG. 9, an illustrative user interface for a mobile device 211-214 is shown, in accordance with aspects of the present disclosure. With the user interface 901, a user of the mobile device 211-214 may input data into the user interface components 902-904 to specify the criteria for a requested condensed media version. In this example, the user interface 901 concurrently allows the user to schedule the actual playing/execution of the condensed media as a task on the mobile device 211-214. For instance, in boxes 902 and 903, a user may input the precise time and date at which the condensed media will start playing, and the precise time and date at which the condensed media should finish. In other examples, boxes 902 and 903 may be replaced with a single text box allowing a user to specify the time duration, a compression ratio, or a size limit for the requested condensed media.

In the series of drop-down boxes 904, the user may first select the type of media (e.g., movies), followed by the specific media work (e.g., Space Mission) for which a condensed version is being requested. In this example, the software application running user interface 901 may populate the hierarchy of drop-down boxes 904 by determining the different media files and/or annotation files that the mobile device 211-214 or the current user is able to access. For instance, drop-down boxes 904 might be populated based on the set of annotation files stored locally in the memory of the mobile device 211-214. Alternatively, a mobile device 211-214 with a media subscription from a service provider may issue a request to the service provider computer for a current set of media works that are available for viewing or executing as condensed versions. The set of available media works may coincide to the set of annotation files stored at the service provider computer, allowing the mobile device 211-214 to issue a request via user interface 901 for a condensed version based on the user's criteria, which may be generated from any of the available annotation files on the fly by the service provider in response to the user's request.

In other examples, additional user interface components may be added to the user interface 901 to allow the user to specify other content-based criteria based on the segment data in the annotation file of the selected media. For instance, after the user selects the movie “Space Mission” from the drop-down boxes 904, the user interface 901 may display an additional drop-down box to allow the user to request a condensed media version that prioritizes one or more of the dramatic elements in the movie (e.g., “Action sequences”, “Comedic Segments”, “Romantic Interlude”), or a drop-down box to allow the user to request a condensed media version that prioritizes the segments featuring the user's favorite characters from the movie.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

1. A method, comprising:
receiving a request for a condensed version of a media work, said request comprising an identifier corresponding to the media work and one or more criteria relating to the requested condensed version the media work;
identifying an annotated version of the media work comprising data corresponding to one or more segments within the media work;
identifying a subset of the segments in the annotated version of the media work to be included in the condensed version of the media work; and
creating the condensed version of the media work comprising data referencing the subset of identified segments in the annotated version of the media work.

2. The method of claim 1, wherein the condensed version of the media work is a separate file from the media work and does not contain any media content of the media work.

3. The method of claim 1, wherein the annotated version of the media work is stored as a separate file from the media work.

4. The method of claim 1, wherein the annotated version of the media work is integrated into the media work.

5. The method of claim 1, wherein the annotated version of the media work comprises a time code reference for each segment within the media work.

6. The method of claim 1, wherein the annotated version of the media work comprises a dramatic content value for each segment within the media work.

7. The method of claim 6, further comprising:
automatically selecting segments to be included in the condensed version of the media work based on the dramatic content value of the selected segments.

8. The method of claim 1, further comprising:
rendering on a digital display a graphical representation of the segments in the annotated version of the media work; and
receiving user selections of segments to be included in the condensed version of the media work.

9. The method of claim 8, wherein the graphical representation comprises a static image from each of a plurality of different segments in the annotated version of the media work.

10. The method of claim 8, wherein the graphical representation comprises a line graph of dramatic content values of the segments in the annotated version of the media work.

11. Apparatus, comprising:
a processor controlling at least some operations of the apparatus; and
a memory storing computer executable instructions that, when executed by the processor, cause the apparatus to perform a method comprising:
receiving a request for a condensed version of a media work, said request comprising an identifier corresponding to the media work and one or more criteria relating to the requested condensed version the media work;
identifying an annotated version of the media work comprising data corresponding to one or more segments within the media work;
identifying a subset of the segments in the annotated version of the media work to be included in the condensed version of the media work; and
creating the condensed version of the media work comprising data referencing the subset of identified segments in the annotated version of the media work.

12. The apparatus of claim 11, wherein the condensed version of the media work is a separate file from the media work and does not contain any media content of the media work.

13. The apparatus of claim 11, wherein the annotated version of the media work is stored as a separate file from the media work.

14. The apparatus of claim 11, wherein the annotated version of the media work is integrated into the media work.

15. The apparatus of claim 11, wherein the annotated version of the media work comprises a time code reference for each segment within the media work.

16. The apparatus of claim 11, wherein the annotated version of the media work comprises a dramatic content value for each segment within the media work.

17. The apparatus of claim 16, the method further comprising:
automatically selecting segments to be included in the condensed version of the media work based on the dramatic content value of the selected segments.

18. The apparatus of claim 11, further comprising a digital display and a physical user interface, wherein the method further comprises:
rendering on the digital display a graphical representation of the segments in the annotated version of the media work; and
receiving user selections via the physical user interface of segments to be included in the condensed version of the media work.

19. The apparatus of claim 18, wherein the graphical representation comprises a static image from each of a plurality of different segments in the annotated version of the media work.

20. The apparatus of claim 18, wherein the graphical representation comprises a line graph of dramatic content values of the segments in the annotated version of the media work.

21. One or more computer readable media storing computer-executable instructions which, when executed on a computer system, perform a method comprising:
receiving a request for a condensed version of a media work, said request comprising an identifier corresponding to the media work and one or more criteria relating to the requested condensed version the media work;
identifying an annotated version of the media work comprising data corresponding to one or more segments within the media work;
identifying a subset of the segments in the annotated version of the media work to be included in the condensed version of the media work; and
creating the condensed version of the media work comprising data referencing the subset of identified segments in the annotated version of the media work.

22. The computer readable media of claim 21, wherein the method further comprises:
automatically selecting segments to be included in the condensed version of the media work based on a dramatic content value stored for the one or more segments.

23. The computer readable media of claim 21, wherein the method further comprises:
rendering on a digital display a graphical representation of the segments in the annotated version of the media work; and
receiving via a physical user interface of the computer system user selections of segments to be included in the condensed version of the media work.

24. A method, comprising:
transmitting a request for a condensed version of a media work, said request comprising an identifier corresponding to the media work and one or more criteria relating to the requested condensed version the media work;
receiving the condensed version of the media work in accordance with the identifier and the one or more criteria; and
causing to be executed the condensed version of the media work.

25. The method of claim 24, wherein the media work comprises a digital data file corresponding to one of a movie file, music file, television programming file, or interactive computer game file.

26. The method of claim 24, wherein the condensed version of the media work is received via a digital video broadcast (DVB) network.

27. The method of claim 24, wherein the one or more criteria comprises a time duration for the condensed version of the media work.

28. The method of claim 24, wherein the request is transmitted by a mobile terminal and wherein the one or more criteria comprises a size limitation based on the available memory of the mobile terminal.

29. The method of claim 24, wherein the request is transmitted by a mobile terminal, the media work comprises an interactive computer game, and the one or more criteria comprises a limitation based on a user interface of the mobile terminal.

30. The method of claim 24, wherein the condensed version of the media work is a separate file from the media work and does not contain any media content of the media work.

31. The method of claim 24, wherein the condensed version of the media work comprises references to a plurality of segments within the media work, each segment reference including one or more time code references to the media work.

32. The method of claim 24, wherein the condensed version of the media work comprises references to a plurality of segments within the media work, and wherein each of the plurality of segments was selected for inclusion in the condensed version of the media work based on the dramatic content value of the segment.

33. Apparatus, comprising:
a processor controlling at least some operations of the apparatus; and
a memory storing computer executable instructions that, when executed by the processor, cause the apparatus to perform a method comprising:
transmitting a request for a condensed version of a media work, said request comprising an identifier corresponding to the media work and one or more criteria relating to the requested condensed version the media work;
receiving the condensed version of the media work in accordance with the identifier and the one or more criteria; and
causing to be executed the condensed version of the media work.

34. The apparatus of claim 33, wherein the media work comprises a digital data file corresponding to one of a movie file, music file, television programming file, or interactive computer game file.

35. The apparatus of claim 33, wherein the condensed version of the media work is received via a digital video broadcast (DVB) network.

36. The apparatus of claim 33, wherein the one or more criteria comprises a time duration for the condensed version of the media work.

37. The apparatus of claim 33, wherein the one or more criteria comprises a size limitation based on the available memory of the apparatus.

38. The apparatus of claim 33, wherein the media work comprises an interactive computer game, and the one or more criteria comprises a limitation based on a user interface of the apparatus.

39. The apparatus of claim 33, wherein the condensed version of the media work is a separate file from the media work and does not contain any media content of the media work.

40. The apparatus of claim 33, wherein the condensed version of the media work comprises references to a plurality of segments within the media work, each segment reference including one or more time code references to the media work.

41. The apparatus of claim 33, wherein the condensed version of the media work comprises references to a plurality of segments within the media work, and wherein each of the plurality of segments was selected for inclusion in the condensed version of the media work based on the dramatic content value of the segment.

42. One or more computer readable media storing computer-executable instructions which, when executed on a computing device, perform a method comprising:
transmitting a request for a condensed version of a media work, said request comprising an identifier corresponding to the media work and one or more criteria relating to the requested condensed version the media work;
receiving the condensed version of the media work in accordance with the identifier and the one or more criteria; and
causing to be executed the condensed version of the media work.

43. A method, comprising:
receiving digital data identifying a media work;
determining a plurality of content segments within the media work;
assigning a dramatic content value to each of the plurality of content segments;
creating a media work annotation file comprising representations of each of the plurality of content segments and dramatic content values; and
storing the media work annotation file as a separate file from the media work, such that the media work annotation file does not contain any media content of the media work.

44. The method of claim 43, wherein the media work comprises an interactive computer game.

45. The method of claim 43, wherein the media work annotation file further comprises time code references for each of the plurality of content segments.

46. The method of claim 43, wherein the media work comprises multiple media files and the media work annotation file further comprises a media file reference for each segment.

47. The method of claim 46, wherein the multiple media files of the media work comprise multiple movies having related content.
